(19) United States
(12) Patent Application Publication
(10) Pub. No.: US 2012/0175493 A1
(43) Pub. Date: Jul. 12, 2012

(54) Fastener-free connection of adjacent concrete formwork tables built with wood I-Joists and wood-based panels

(75) Inventors: Stephen Aikman, Boise, ID (US); Jeffery Christopher Jack, Boise, ID (US)

(73) Assignee: RedBuilt, LLC, Boise, ID (US)

(21) Appl. No.: 12/930,674

(22) Filed: Jan. 12, 2011

(51) Int. Cl. B29C 37/00

(52) U.S. Cl. 249/187.1

(57) ABSTRACT

The invention provides a means for making a reusable, non-destructive connection of adjacent formwork tables constructed of wood I-Joists and wood-based plyform sheathing. The connection may be made and removed by workers below in a way that does not damage the forms.

### CROSS-REFERENCE TO RELATED APPLICATIONS

N/A

### STATEMENT REGARDING FEDERALLY SPONSORED R&D

N/A

### REFERENCE TO LISTINGS/TABLES ON CD

N/A

### BACKGROUND OF THE INVENTION: THIS INVENTION PERTAINS TO THE FOLLOWING U.S. PATENT CLASSIFICATION(S)

Class 249 Static Molds

Sub-Class 187.1 Mold Element

Sub-Class 188 In-situ construction engineering or building type

Sub-Class 189 Form panel

Sub-Class 192 Including means to connect abutting panel sections

This invention pertains to the means of connecting formwork tables constructed of wood I-Joists and wood-based plyform sheathing (e.g. MDO). The use of the aforementioned formwork tables in the construction process is common in the forming of elevated horizontal concrete slabs. Such tables are typically supported from shoring towers and transverse beams, which transfer the loads from freshly poured concrete to the floor below. Tables are typically fabricated on the ground (either on-site or at another location) in a geometry such that the table width is the long dimension of the plyform sheathing (commonly 8′) and the table length is the building's bay width (beam-to-beam dimension) minus the width of the beam, its associated formwork and a small gap between the two form components. Individual tables frequently are built in a way that the plyform sheathing butts together over the centerline of an I-Joist. The practice of butting sheathing over a single joist results in even spacing of formwork materials across the table width and relatively uniform deflection across the table width. The I-Joist under which the sheets are butted is fastened to the sheathing on one table with a typical fastening to the other I-Joists. Once forms are placed on the transverse beams in preparation for pouring concrete, it is common practice to provide a physical attachment (nail or screw) from this I-Joist to the plyform sheathing of the adjacent panel. This in-field connection is damaging to both the I-Joist and the plyform sheathing due to the stripping process and the fact that this connection must be made/undone every time the table is poured on. (See FIG. 2 showing current practice.)

### BRIEF SUMMARY OF THE INVENTION

The invention is a means to provide a positive connection between two formwork tables constructed of wood I-Joists and wood-based plyform sheathing that can be made multiple times without compromising integrity or condition of the formwork. The invention provides a connection that can be made by workers below, rather than requiring that someone make a connection from above. The invention provides a tight connection between adjacent tables, which minimizes concrete seepage through the joint, which aids in the form-stripping process and provides a clean joint. The invention eliminates the need for nails/screws in abutting adjacent tables over a joist, thus eliminating the damage to both the I-Joist and the plyform sheathing edge.

### BRIEF DESCRIPTION OF THE SEVERAL VIEWS OF THE DRAWING

FIG. 1: Form Tables with Wood I-Joists and Wood-Based Plyform Sheathing

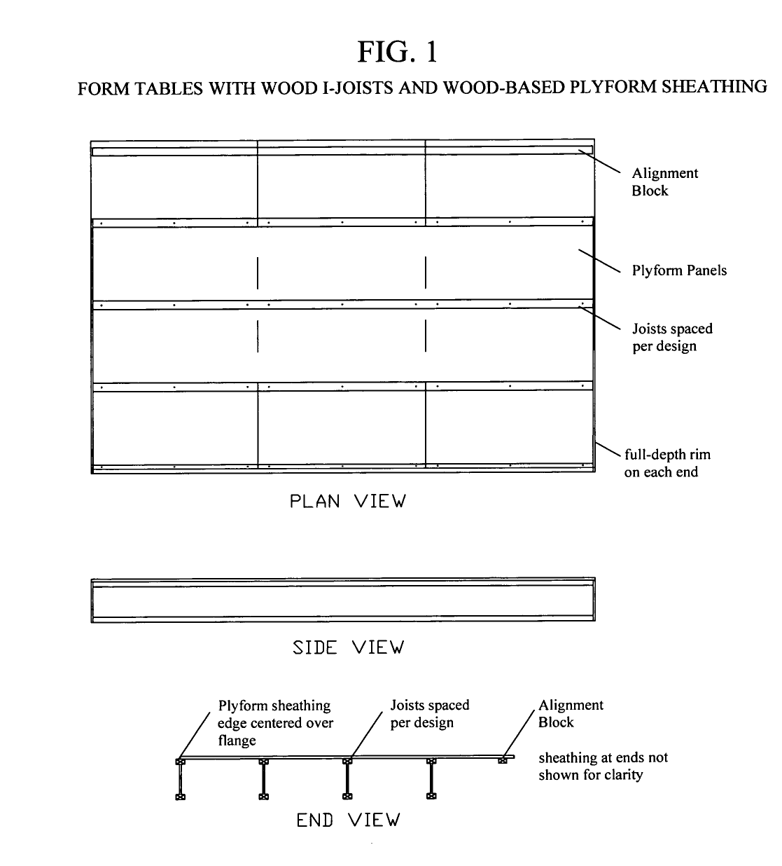

FIG. 2: Current Practice for Connecting Adjacent Formwork Tables

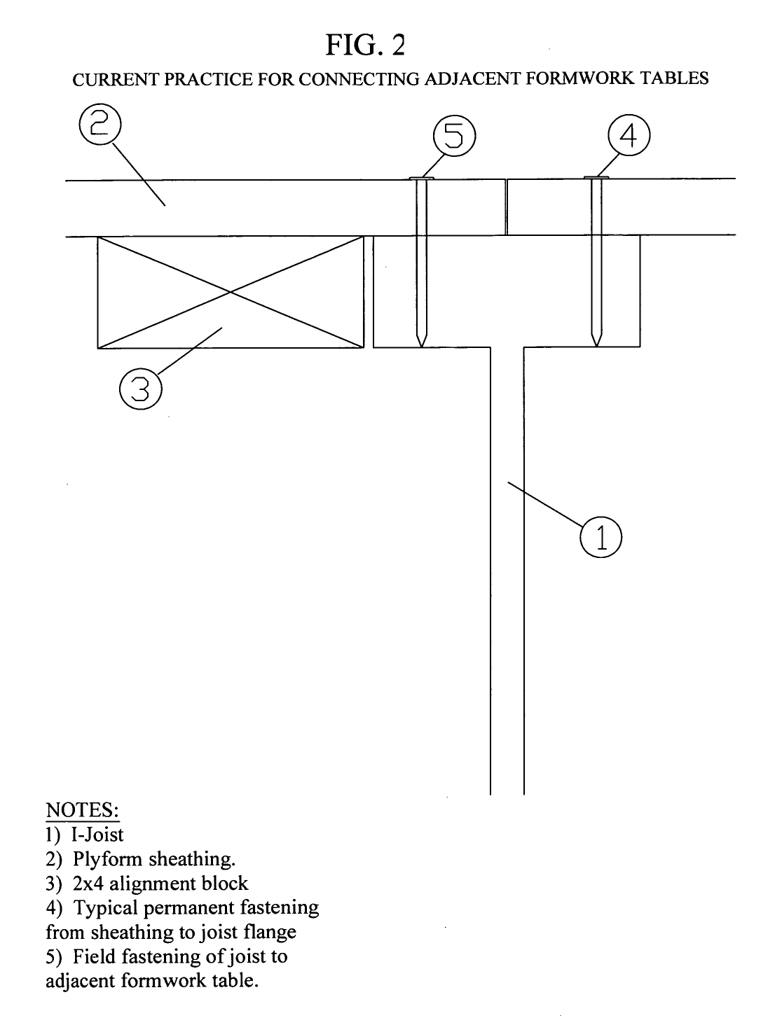

FIG. 3: Fastener-Free Connection of Adjacent Formwork Tables

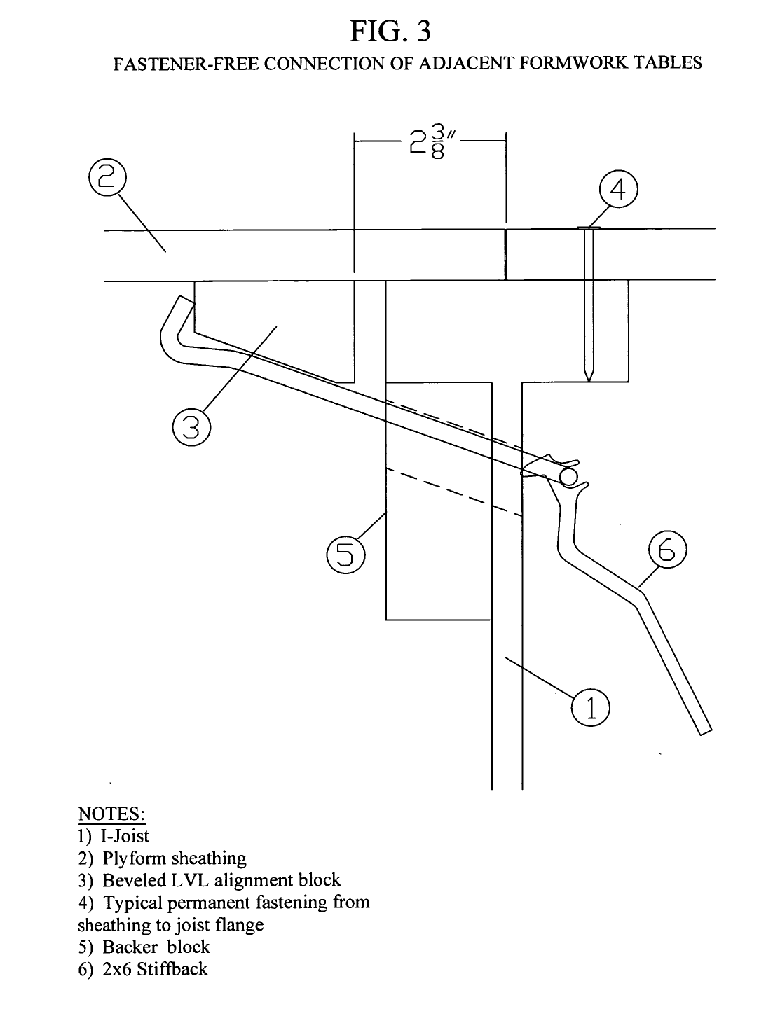

FIG. 4: Individual Component Diagrams

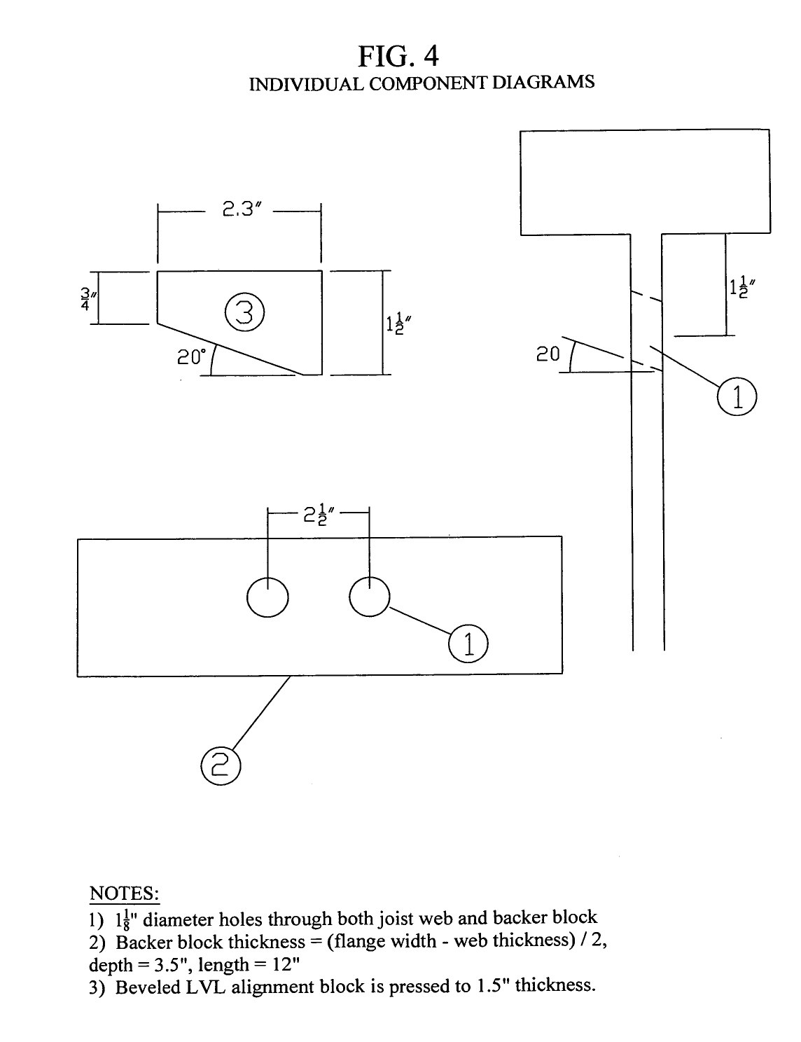

### DETAILED DESCRIPTION OF THE INVENTION

The invention includes the proper machining, shaping, location and connection of four separate components that are each individually described below. Each of these four components are needed for proper tightness of the abutted connection and proper durability of the materials.

Component #1 is the I-Joist. The joist described may have flange thicknesses of 1.5″-1.75″ and may have flange widths of 2.5″-3.5″. The joist intended to be used in making this connection will have two holes of 1.125″ diameter drilled through the web. The holes are located such that their centers are 1.5″ beneath the bottom face of the joist's top flange, and are located 2.5″ apart from each other down the length of the joist. The holes in the web are drilled at a 20-degree incline from the horizontal. The I-Joist is physically attached by nail or screw to the plyform sheathing of the table to which it is a member, using the typical fastening schedule for the joist-sheathing connection (commonly called out to be fasteners spaced at 12-24″ on-center). The I-Joist is oriented such that the incline in the holes points up toward the adjacent formwork table.

Component #2 is the backer block. The backer block is a wood block whose purpose is to prevent damage to the web-to-flange rout of the I-Joist. The block provides resistance to rotation of the web in relation to the flange when the connection to adjacent tables is made. The thickness of the backer block is equal to half of the joist's flange width minus its web thickness. (For example: An I-Joist with a 3.5″ wide flange and a 7/16″ thick web would use a backer block with a thickness of 1/2*(3-½″− 7/16″)=1.53″→A 1.5″ thick block is chosen.) The other size dimensions of the backer block are not critical, but will typically be chosen as 3.5″ for height and 12″ for length. The backer block is attached to the web of Component #1 on the side facing towards the adjacent formwork table. The connection is made by a minimum of two nails or staples located so as not to split the block. The backer block also has two holes of 1.125″ diameter as described in Component #1. The holes are located to align directly with those made in the web of Component #1 (same spacing, location, and incline from the horizontal), and are most conveniently made by first attaching the backer block to the I-Joist web before drilling the holes. The holes are centered along the length of the backer block.

Component #3 is the shaped Laminated Veneer Lumber (LVL) plate. The LVL plate is 1.5″ thick and 2.3″ wide and may vary in length. Component #3 is oriented such that the wide face of veneers will be 2.3″ wide and in direct contact with the plyform sheathing. A bevel cut down the full length of the LVL plate is made at a 20-degree incline from the horizontal. The bevel cut starts at centerline of the plate's thickness (¾″ down from one face) and extends across the plate to approximately ¼″ from the opposite face. The LVL plate is attached to the plyform sheathing of the abutting table to which component #1 will be attached. Location of the LVL plate is such that the plyform sheathing cantilevers 2-⅜″ beyond the face of the LVL plate. Orientation of the LVL plate is such that the 1.5″ thick face points toward the cantilevered plywood edge. Attachment of the LVL plate to the plyform sheathing uses minimum 1.5″ long nails/screws located at 12″ o.c. down its length.

Component #4 is a 2×6 Stiffback as Manufactured by Gates & Sons; it consists of a shaped-steel hook physically attached to a shaped steel cam. The arm-length of the wire hooks is 6″ (typically used for connections to 2×6′s). The wire hooks are pointed away from the pivot point of the cam-head (this may require rotating the wire hooks from off-the-shelf 2×6 Stiffback hardware). The wire hook ends are threaded through the holes in Components #1 and #2 such that they are facing upwards toward the plyform sheathing; once installed through the holes, the pivot point of the cam-head should be faced down such that when the lever arm is pulled down the pivot point rotates upward directly against the web of Component #1.

The physical connection of the two adjacent form tables is made by the following process: Place the two adjacent form tables next to one another such that the 2-⅜″ cantilevered edge of plyform sheathing begins to overlap over the top flange of Component #1. Once the two tables are close enough, reach up on either side of Component #1 such that you are holding both sides of Component #4. With one hand, push upward on the wire hooks against the beveled face of Component #3. Simultaneously, with the other hand, pull downward on the lever arm of Component #4, which will rotate the cast lever and pull the two tables together. The lever should be pulled down tight to fully engage the connection. (Note that a tight lock of the connection is needed for proper performance during installation and pours. After numerous reuses, adjustments may need to be made such as replacement of Component #1 and/or #3, shifting the connection other locations, additional connections, etc.)

The physical connection of the two adjacent form tables is removed by lifting up on the lever of Component #4, and allowing its wire hooks to fall away from Component #3.

1. A formwork table arrangement comprising multiple longitudinal joist members with the transitional joist member fastened to the diaphragm sheathing such that the sheathing edge is vertically aligned over the joist's centerline, said formwork table comprising a shaped alignment block parallel to the joists along the diaphragm's cantilevered edge, said transitional joist member being reinforced with a plurality of rectangular support blocks, said transitional joist member and the plurality of rectangular support blocks comprising a plurality of holes positioned to allow for engaging a latching mechanism with a pivoting lever arm and projecting hooks oriented such that the hooks can engage the shaped alignment block on the cantilevered edge of the adjacent formwork table, said latching mechanism provides means to engage members of adjacent tables and create a linear motion of tables transverse to the table length so as to provide a tight joint along the longitudinal juncture between adjacent formwork table diaphragms.

2. The shaped alignment block according to claim one has a beveled edge whose angled incline matches the angled incline of the holes drilled through the transitional joist member and plurality of rectangular support blocks according to claim one.

3. The plurality of support blocks according to claim one are positioned to the outward edge of the table to which the transitional joist member is fastened.

4. The shaped alignment block and transitional joist member according to claim one are fastened to the diaphragm sheathing by a plurality of steel fasteners at regular longitudinally spaced intervals.

5. The latching mechanism with a pivoting lever arm and projecting hooks according to claim one consist of a cast lever arm with a pivoting head and a plurality of ears that encase a wire hook.
